(19) United States
(12) Patent Application Publication
(10) Pub. No.: US 2009/0092074 A1
(43) Pub. Date: Apr. 9, 2009

(54) AERONAUTICAL AD-HOC NETWORKS

(75) Inventors: Abbas Jamalipour, New South Wales (AU); Ehssan Sakhaee, New South Wales (AU)

Correspondence Address: BRINKS HOFER GILSON & LIONE, P.O. BOX 10395, CHICAGO, IL, 60610, US

(73) Assignee: THE UNIVERSITY OF SYDNEY, Sydney (AU)

(21) Appl. No.: 12/094,535

(22) PCT Filed: Nov. 20, 2006
(86) PCT No.: PCT/AU2006/001747

§ 371 Date: Dec. 3, 2008

(30) Foreign Application Priority Data
Nov. 22, 2005 (AU) 2005906493

(51) Int. Cl. H04B 7/185; H04B 7/15

(52) U.S. Cl. 370/316; 455/11.1; 455/12.1

(57) ABSTRACT

A communications network architecture (200) enabling a first aircraft (102) to establish a communication path with a second aircraft (105) is disclosed. The architecture comprises a satellite network layer (111) enabling the first aircraft (102) to establish the communication path with the second aircraft (105) via a satellite, a terrestrial network layer (110) enabling the first aircraft (102) to establish the communication path with the second aircraft (105) via the satellite and an associated ground station, and an aircraft network layer (202) enabling the first aircraft (102) to establish the communication path with the second aircraft (105) via another aircraft.

### FIELD OF THE INVENTION

The present invention relates generally to communication networks, and in particular, to networks for aircraft in flight.

### BACKGROUND

FIG. 1 shows a typical network architecture for providing communication services to aircraft in flight. In the two-layer architecture, two aircraft 102 and 105 communicate with each other. In order for the aircraft 102 to communicate with the aircraft 105, in one arrangement, the aircraft 102 establishes an intra-satellite layer link 114 to a satellite 101, which communicates via an inter-layer link 103 to a ground station 107. The ground station 107 communicates via an inter-layer link 115 back to the satellite 101, which communicates via an intra-layer link 104 with the aircraft 105. Geo-synchronous satellites such as 101 in FIG. 1 orbit at an altitude of approximately 36,000 km above the earth, and introduce transmission delay that causes problems for communication of time sensitive information such as video.

### SUMMARY

It is an object of the present invention to substantially overcome, or at least ameliorate, one or more disadvantages of existing arrangements.

Disclosed are arrangements, referred to as aeronautical ad-hoc network (AHXNET) arrangements, which seek to address the above problems by adding a third network layer 202 (see FIG. 2), referred to as the aircraft network layer, to the current two-layer network architecture.

FIG. 2 shows a representation of the disclosed AHXNET network architecture, and how intra-layer links 201 can be established, using single-hop or multi-hop techniques between aircraft in the aircraft network layer 202. This arrangement can be used instead of the multiple links described in relation to FIG. 1, or as an additional capability thereto.

According to a first aspect of the present invention, there is provided a system for establishing, in-flight, a communication path between a first aircraft and a second aircraft, the system comprising:

means for identifying another aircraft;

means for determining relative velocities between at least some of the first aircraft the second aircraft and the other aircraft;

means for matching the relative velocities against a criterion; and

means for establishing, if said relative velocities match the criterion, communication path segments between successive pairs of said first aircraft, said second aircraft and said other aircraft to thereby form the communication path.

According to another aspect of the present invention, there is provided a system for establishing, in-flight, a communication path between a first aircraft and a second aircraft, the system comprising:

one or more memories for storing a program; and

one or more processors for executing the program, said program comprising:

code for identifying another aircraft;

code for determining relative velocities between at least some of the first aircraft the second aircraft and the other aircraft;

code for matching the relative velocities against a criterion; and

code for establishing, if said relative velocities match the criterion, communication path segments between successive pairs of said first aircraft, said second aircraft and said other aircraft to thereby form the communication path.

According to another aspect of the present invention, there is provided a computer program for directing one or more processors to execute a procedure for establishing, in-flight, a communication path between a first aircraft and a second aircraft, said program comprising:

code for identifying another aircraft;

code for determining relative velocities between at least some of the first aircraft the second aircraft and the other aircraft;

code for matching the relative velocities against a criterion; and

code for establishing, if said relative velocities match the criterion, communication path segments between successive pairs of said first aircraft, said second aircraft and said other aircraft to thereby form the communication path.

According to another aspect of the present invention, there is provided a computer program product including a computer readable medium having recorded thereon a computer program for directing one or more processors to execute a procedure for establishing, in-flight, a communication path between a first aircraft and a second aircraft, said program comprising:

code for identifying another aircraft;

code for determining relative velocities between at least some of the first aircraft the second aircraft and the other aircraft;

code for matching the relative velocities against a criterion; and

code for establishing, if said relative velocities match the criterion, communication path segments between successive pairs of said first aircraft, said second aircraft and said other aircraft to thereby form the communication path.

According to another aspect of the present invention, there is provided a method of establishing, in-flight, a communication path between a first aircraft and a second aircraft, the method comprising the steps of:

identifying another aircraft;

determining relative velocities between at least some of the first aircraft the second aircraft and the other aircraft;

matching the relative velocities against a criterion; and

establishing, if said relative velocities match the criterion, communication path segments between successive pairs of said first aircraft, said second aircraft and said other aircraft to thereby form the communication path.

According to another aspect of the present invention, there is provided a communications network architecture enabling a first aircraft to establish a communication path with a second aircraft, said architecture comprising:

a satellite network layer enabling the first aircraft to establish said communication path with the second aircraft via a satellite;

a terrestrial network layer enabling the first aircraft to establish said communication path with the second aircraft via the satellite, and an associated ground station; and

an aircraft network layer enabling the first aircraft to establish said communication path with the second aircraft via another aircraft.

According to another aspect of the present invention there is provided a computer program product including a computer readable medium having recorded thereon a computer program for directing a processor to execute any one of the methods described above.

According to another aspect of the present invention there is provided a method of establishing, in-flight, a communication path between a first aircraft and a second aircraft, the method comprising the steps of:

identifying another aircraft;

determining relative velocities between some or all of the first aircraft, the second aircraft and the other aircraft;

matching the relative velocities against a criterion; and

establishing, if said relative velocities match the criterion, said communication path between the first aircraft and the second aircraft via said other aircraft.

According to another aspect of the present invention there is provided a method of establishing, in-motion, a communication path between a first mobile platform and a second mobile platform, the method comprising the steps of:

identifying another mobile platform;

determining relative velocities between at least some of the first mobile platform the second mobile platform and the other mobile platform;

matching the relative velocities against a criterion; and

establishing, if said relative velocities match the criterion, communication path segments between successive pairs of said first mobile platform, said second mobile platform and said other mobile platform to thereby form the communication path.

According to another aspect of the present invention there is provided a method of establishing, in-flight, a communication path between a first aircraft and a second aircraft, the method comprising the steps of:

identifying a plurality of other aircraft;

determining relative velocities between some or all of the first aircraft, the second aircraft and the plurality of other aircraft;

selecting at least some of the plurality of aircraft dependent upon the relative velocities;

establishing successive communication path segments between successive pairs of the at least some of the plurality of aircraft, wherein a concatenation of said successive communication path segments forms said communication path.

According to another aspect of the present invention there is provided a system for establishing, in-flight, a communication path between a first aircraft and a second aircraft, the system comprising:

one or more memories for storing a program; and

one or more processor for executing the program, said program comprising:

code for identifying a plurality of other aircraft;

code for determining relative velocities between some or all of the first aircraft, the second aircraft and the plurality of other aircraft;

code for selecting at least some of the plurality of aircraft dependent upon the relative velocities; and

code for establishing successive communication path segments between successive pairs of the at least some of the plurality of aircraft, wherein a concatenation of said successive communication path segments forms said communication path.

According to another aspect of the present invention there is provided a computer readable medium upon which is recorded a computer program for directing one or more processors to execute a procedure for establishing, in-flight, a communication path between a first aircraft and a second aircraft, said program comprising:

code for identifying a plurality of other aircraft;

code for determining relative velocities between some or all of the first aircraft, the second aircraft and the plurality of other aircraft;

code for selecting at least some of the plurality of aircraft dependent upon the relative velocities; and

code for establishing successive communication path segments between successive pairs of the at least some of the plurality of aircraft, wherein a concatenation of said successive communication path segments forms said communication path.

Other aspects of the invention are also disclosed.

### BRIEF DESCRIPTION OF THE DRAWINGS

Some aspects of the prior art and one or more embodiments of the present invention will now be described with reference to the drawings, in which:

FIG. 1 shows a prior-art network architecture;

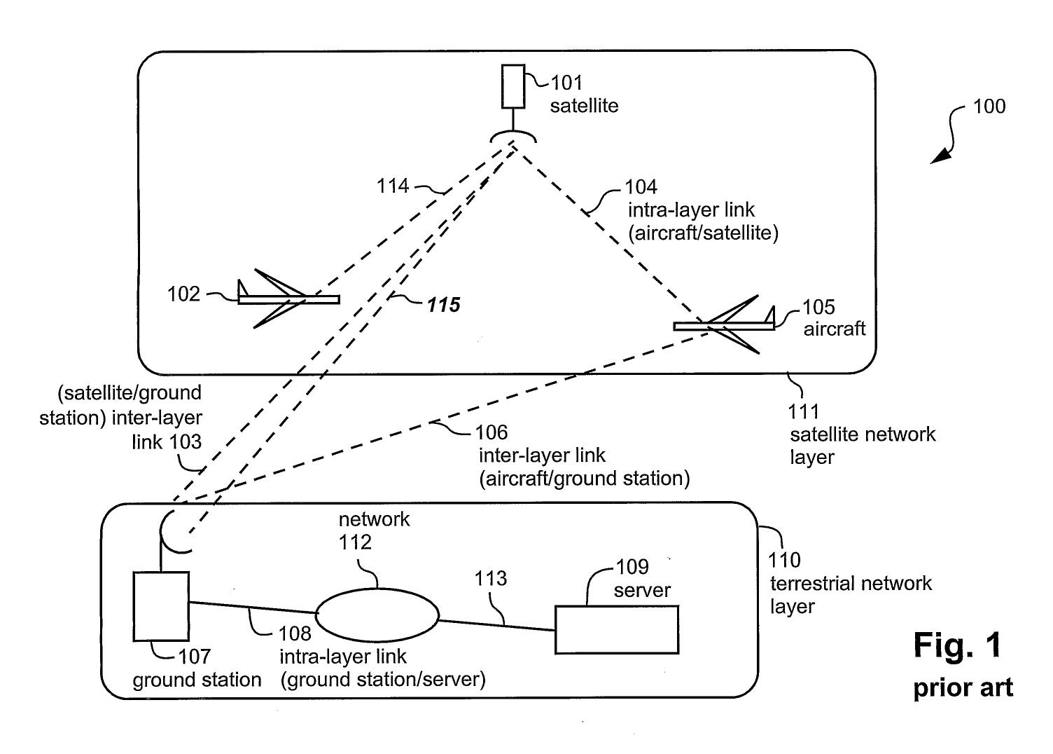

FIG. 2 shows the disclosed AHXNET network architecture;

FIG. 3 depicts a functional block diagram of a general-purpose interconnected computer system upon which described AHXNET methods can be practiced;

FIG. 4 shows a geometric representation of a Line of Sight (LOS) communication zone;

FIG. 5 shows the probability of finding at least n planes in the area S at any one time for the United States;

FIG. 6 is a process flow chart for effecting communication according to the disclosed AHXNET arrangements;

FIG. 7 depicts an aeronautical mobility model;

FIG. 8 depicts establishment of a receive path taking mobility behaviour of the aircraft into account;

FIG. 9 depicts relative node suitability as a function of Doppler shift for an aircraft requesting data;

FIG. 10 depicts another example of establishment of a receive path taking mobility behaviour of aircraft into account;

FIG. 11 shows a process flow chart of how the receive path of FIG. 10 is derived;

FIG. 12 depicts establishment of a transmit path in an example with receding nodes;

FIG. 13 shows an example of establishment of a transmit path using a Radial Routing Scheme;

FIGS. 14-16 show another example of establishment of a transmit path using a Radial Routing Scheme in more detail;

FIG. 17 shows a process flow chart for the example of FIGS. 14-16; and

FIG. 18 depicts numerical simulation results for AHXNET examples.

### DETAILED DESCRIPTION INCLUDING BEST MODE

It is to be noted that the discussions contained in the “Background” section and that above relating to prior art arrangements relate to discussions of arrangements that form public knowledge through their use. The present inventor(s) or patent applicant(s) does not represent, by such discussions, that such arrangements in any way form part of the common general knowledge in the art.

Where reference is made in any one or more of the accompanying drawings to steps and/or features, which have the same reference numerals, those steps and/or features have for the purposes of this description the same function(s) or operation(s), unless the contrary intention appears.

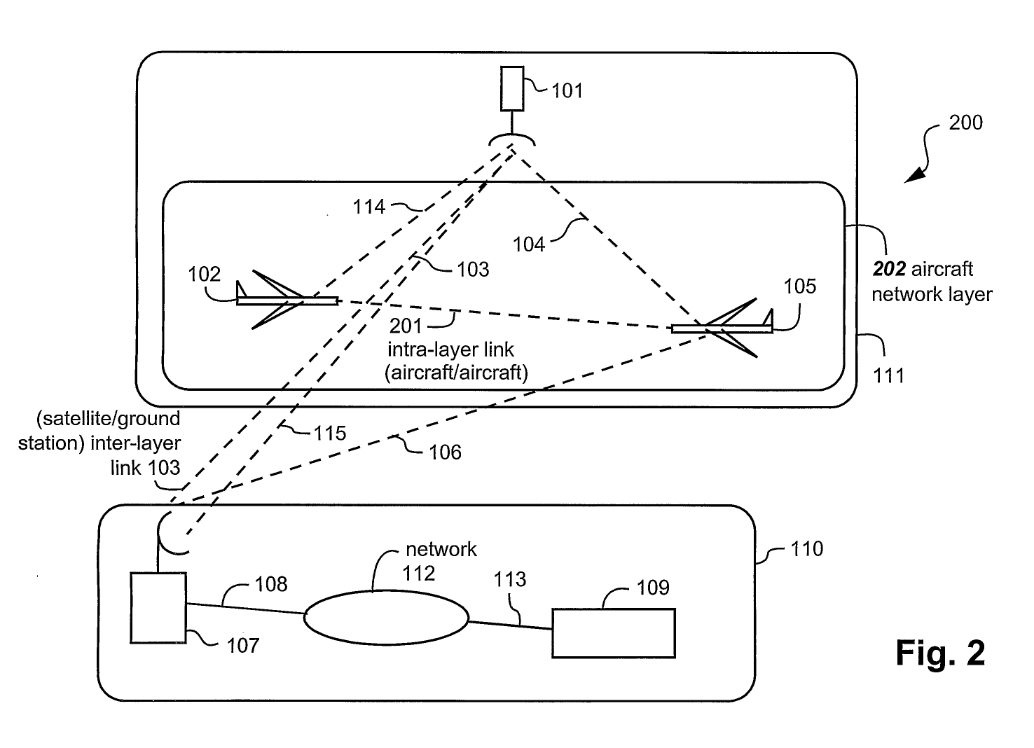

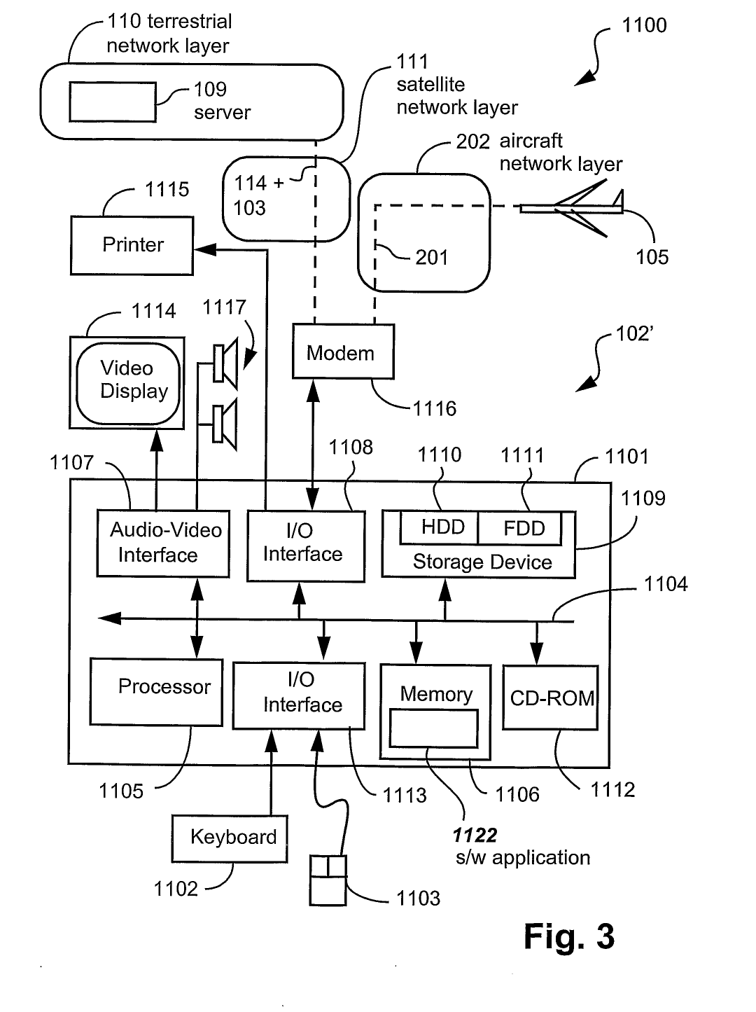

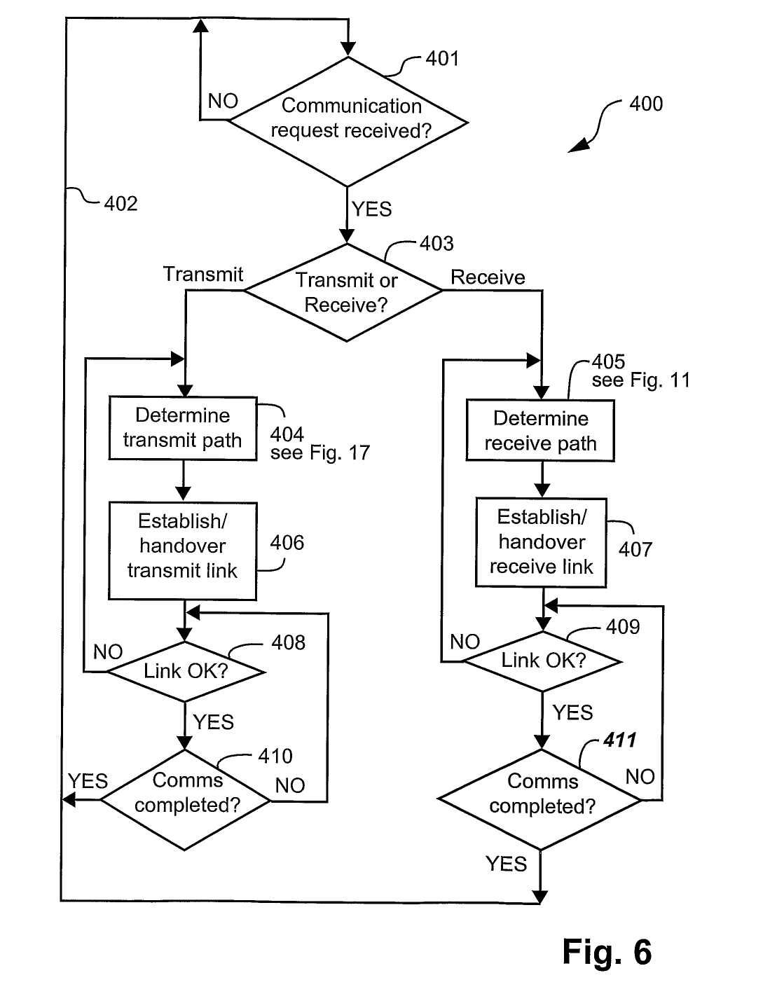

FIG. 3 depicts a functional block diagram of a general-purpose interconnected computer system 1100 upon which described AHXNET methods can be practiced. The AHXNET method particularly lends itself to implementation on an interconnected general-purpose computer system 1100, such as that shown in FIG. 3 wherein the processes of FIGS. 6, 11 and 17 may be implemented as software, such as an inter-operating suite of software application programs executing within the computer system 1100. In particular, the steps of the AHXNET method are carried out by instructions in the software modules that are carried out by the computer. FIG. 3 depicts one AHXNET system 102′ that is located on the aircraft 102 (see FIG. 2), and infers another AHXNET system (not explicitly shown), on the aircraft 105.

The instructions may be formed as one or more code modules, each for performing one or more particular tasks. Each software module may also be divided into two separate parts, in which a first part performs the AHXNET methods and a second part manages a user interface between the first part and the user. The software may be stored in a computer readable medium, including the storage devices described below, for example. The software is loaded into the computers from the computer readable medium, and then executed by the computers. A computer readable medium having such software or computer program recorded on it is a computer program product. The use of the computer program product in the computer preferably effects an advantageous apparatus for the AHXNET method.

The computer system 1100 is formed by the computer module 102′ (effecting the AHXNET system for the aircraft 102; see FIG. 2), as well as computer modules (not shown) in the server 109 and the second aircraft 105. The following description is largely directed at the computer module 102′, however a similar description applies to the computer modules (not shown) in the server 109 and the second aircraft 105.

The computer module 102′ includes input devices such as a keyboard 1102 and mouse 1103, output devices including a printer 1115, a display device 1114 and loudspeakers 1117. A Modulator-Demodulator (Modem) transceiver device 1116 is used by the computer module 102′ for communicating to and from the server 109 via the appropriate communication links 114 and 103 that are associated with the satellite network layer 111. The Modem transceiver device 1116 is also used by the computer module 102′ for communicating to and from the computer modules (not shown) on the aircraft 105 via the appropriate communication link 201 that is associated with the aircraft network layer 202.

The computer module 102′ typically includes at least one processor unit 1105, and a memory unit 1106, for example formed from semiconductor random access memory (RAM) and read only memory (ROM). The module 1101 also includes a number of input/output (I/O) interfaces including an audio-video interface 1107 that couples to the video display 1114 and loudspeakers 1117, an I/O interface 1113 for the keyboard 1102 and mouse 1103 and optionally a joystick (not illustrated), and an interface 1108 for the modem 1116 and printer 1115. In some implementations, the modem 11116 may be incorporated within the computer module 1101, for example within the interface 1108.

A storage device 1109 is provided and typically includes a hard disk drive 1110 and a floppy disk drive 1111. A magnetic tape drive (not illustrated) may also be used. A CD-ROM drive 1112 is typically provided as a non-volatile source of data. The components 1105 to 1113 of the computer module 1101, typically communicate via an interconnected bus 1104 and in a manner that results in a conventional mode of operation of the computer system 1100 known to those in the relevant art. Examples of computers on which the described arrangements can be practised include IBM-PC's and compatibles, Sun Sparcstations or alike computer systems evolved therefrom.

Typically, the AHXNET software application for the aircraft 102 is resident on the hard disk drive 1110 and read and controlled in its execution by the processor 1105. Intermediate storage of the program and any data fetched from the network 1120 may be accomplished using the semiconductor memory 1106 (as depicted by 1122), possibly in concert with the hard disk drive 1110. In some instances, the application program may be supplied to the user encoded on a CD-ROM or floppy disk and read via the corresponding drive 1112 or 1111, or alternatively may be read by the user from the network 1120 via the modem device 1116.

Still further, the software modules can also be loaded into the computer system 1100 from other computer readable media. The term “computer readable medium” as used herein refers to any storage or transmission medium that participates in providing instructions and/or data to the computer system 1100 for execution and/or processing. Examples of storage media include floppy disks, magnetic tape, CD-ROM, a hard disk drive, a ROM or integrated circuit, a magneto-optical disk, or a computer readable card such as a PCMCIA card and the like, whether or not such devices are internal or external of the computer module 102′. Examples of transmission media include radio or infra-red transmission channels as well as a network connection to another computer or networked device, and the Internet or Intranets including e-mail transmissions and information recorded on Websites and the like.

The AHXNET method may alternatively be implemented in dedicated hardware modules such as one or more integrated circuits performing the functions or sub functions of the AHXNET technique. Such dedicated hardware modules may include graphic processors, digital signal processors, or one or more microprocessors and associated memories.

The disclosed AHXNET arrangements relate to the aircraft network layer 202 (see FIG. 2), where aircraft directly communicate with each other. Due to the high mobility of aircraft, the aircraft network layer 202 falls into what is referred to as the Mobile Ad hoc NETwork (MANET) category. Having regard to ad hoc networking in aeronautical systems, mobility behaviours can advantageously be taken into account, as different mobile devices have different mobility properties and characteristics such as speed, direction, randomness, and consistency of motion. The mobility characteristics of mobile entities can have a significant effect on the communication and routing of the system. One disclosed example of the AHXNET arrangement considers selecting suitable nodes when it comes to finding best paths for routing. The term suitability refers to corresponding nodes with similar mobility characteristics and relative motion, and to a lesser extent to their relative positions with respect to each other. A node suitability metric is described.

Ad hoc networking among commercial aircraft can be useful, as aircraft can share their on-board cached data and Internet access. An inter-network of aircraft can be implemented, in the form of the aircraft network layer 202, by using multi-hop routing among aircraft. This aircraft network layer 202 has a corresponding mobility model. Aircraft travel at high velocities, and in some arrangements, this can assist in selecting more suitable paths that have longer link durations. Aircraft generally travel in almost linear routes for most of their journeys, until they approach the vicinity of the airport. In the disclosed AHXNET arrangements, any aircraft should be able to see at least one other aircraft at any time in order for multi-hop routing to be possible.

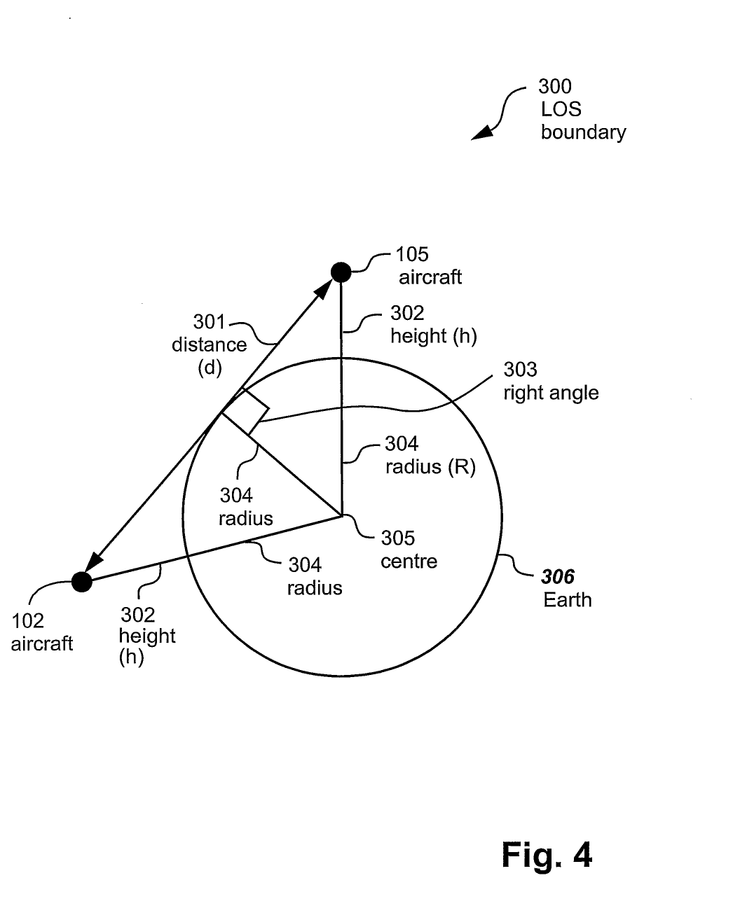

FIG. 4 shows a geometric representation of a Line of Sight (LOS) communication zone, in which the only factor limiting aircraft-to-aircraft communication range is the Earth's curvature. In this case, the maximum range for single-hop communication can be described by the following relationship:

d=2\sqrt{2Rh+h²} [1A]

The area of the line of sight (LOS) communication zone S is calculated using the following mathematical relationship:

S=π(2Rh+h²) which considering the small value of h can be simplified to

S=2πRh [1]

where:

S is the area within the LOS boundary (in km²);

R is the radius of the Earth; and

h is the altitude of the aircraft.

The Earth's radius is approximately 6378 km, and h is typically set to 9 km (the average cruise altitude of most commercial and general aviation aircraft is between 8 km to 11 km).

The number of airplanes n in the region S can be determined using a Poisson distribution, as follows:

$$p ( n , S ) = \frac{{( λ S )}^{″}}{n !} {e}^{- λ S} \qquad [ 2 ]$$

### Where:

p(n,S) is the probability of finding n aircraft in region S; and

λ is the average density of aircraft.

The representation 306 of the earth is shown to have a radius 304. The aircraft 102 flies at a height 302 above the surface of the earth 308, and the aircraft 105 flies at the same height 302 above the surface of the earth 308. The maximum distance between the aircraft 102 and 105 enabling line of sight visibility is established by the curvature of the earth 308 and is depicted by an arrow 301.

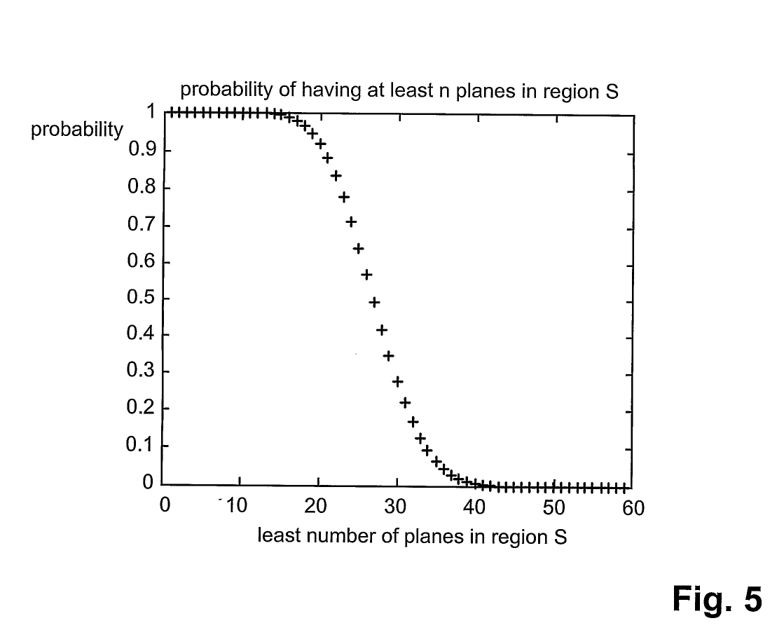

FIG. 5 shows the probability of finding at least n aircraft in the area S at any one time for the United States. The minimum number of aircraft in S needed to practice the AHXNET approach is two, in order to implement single-hop and multi-hop routing. From FIG. 5 it is seen that the probability of finding two or even up to a dozen nodes (ie aircraft that can participate in the disclosed AHXNET arrangements) within S is close to 100%.

The proposed AHXNET routing schemes are dynamic. The satellite network layer 111 can be used to determine position and velocity information for the aircraft in the aircraft network layer 202. Alternately, an arrangement for discovering routes dynamically, without requiring pre-determined data for aircraft routes and positions, can be used.

Shortest path and other routing techniques can be used to implement AHXNET arrangements. However, the “best” path in a MANET is not necessarily the shortest path. For example a shortest path route can be broken before a download is complete, as a result of a node (aircraft) leaving the communication zone. The link or path duration and stability of AHXNET arrangements can be improved by considering path suitability.

The disclosed AHXNET arrangements that consider path suitability take account of mobility in determination of routing. Two modes of routing are disclosed, both of which take into account mobility as a parameter in their routing procedure.

Choose Longest Duration Path (CLDP) selects the path with the longest path duration (based on durations of individual path segments) and can be based on consideration of the Doppler factor. This is advantageously used for reception of data.

Send on Longest Duration Path (SLDP) extends CLDP by applying mobility rules in order to select a suitable path that has a stable path-duration long enough to send some data. This is used advantageously to transmit data.

Although these two modes CLDP and SLDP are described in relation to ad hoc networking among aircraft, the techniques can also be used for other mobile ad hoc networking applications involving mobile platforms by considering specific mobility models for those applications. The disclosed AHXNET arrangements can use flooding for dynamic route discovery.

In the aircraft network layer 202, aircraft generally have predefined paths that they must follow. Randomness is confined primarily to minor route changes to avoid bad weather, and to delayed schedules.

Another characteristic of the aeronautical model is the high speed of the aircraft, being around 800 km/h. This impacts radio communication causing a Doppler shift which results in apparent change to the frequencies of radio signals transmitted to and from aircraft. This Doppler shift is used advantageously in some of the disclosed AHXNET arrangements.

Any aircraft can see a set of other aircraft that are within its line-of-sight (LOS) communication zone. These visible aircraft are considered one-hop neighbors. Once these single-hop neighbors leave the LOS or range of the airplane, (ie once they exit the LOS communication zone) they can no longer directly communicate (ie via a single-hop) with the primary aircraft. If an aircraft is associated with its neighboring aircraft for routing data, and the neighboring aircraft leaves the LOS communication zone of the primary (requesting) aircraft, then the communication link between the aircraft breaks.

Although a sequence of communication links can be established using handover techniques, the preferable disclosed AHXNET arrangements aim to retain the link and path duration for the time necessary to complete the communication session, and hence increase the LOS duration of aircraft that are communicating with each other.

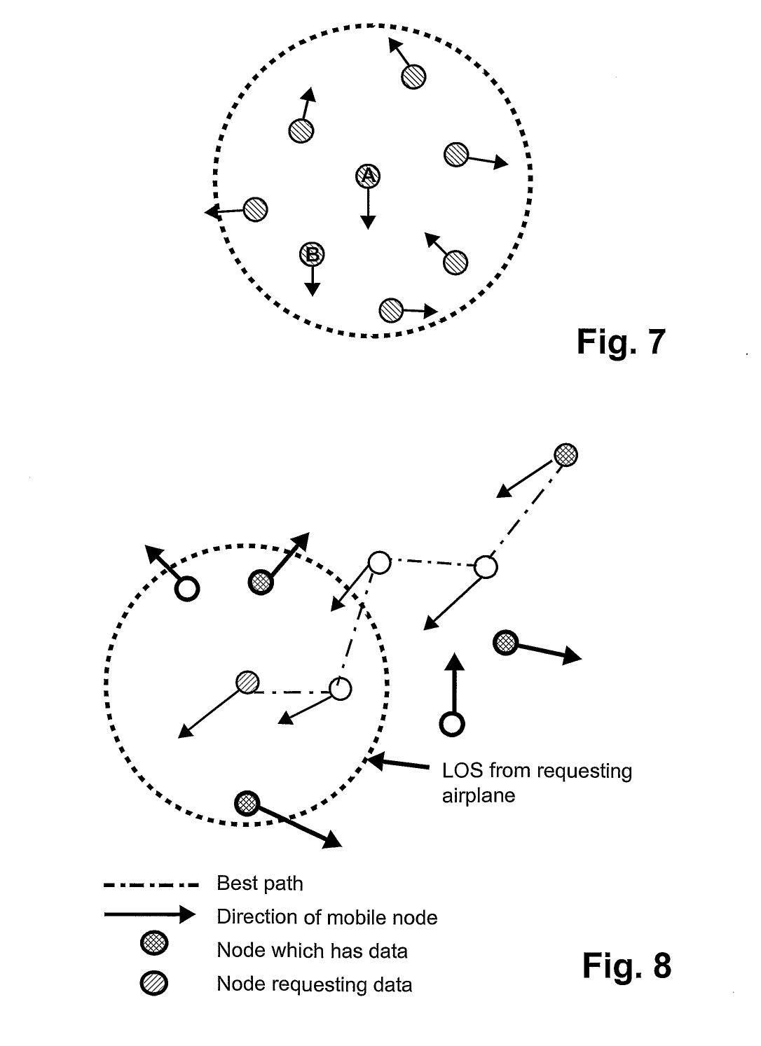

An aeronautical mobility model is illustrated in FIG. 7. In this mobility model, aircraft (ie nodes) may be moving above or below each other, since aircraft are not all at the same altitude, forming the 3-D aircraft network layer 202 of mobile nodes.

In the preferred disclosed AHXNET arrangements, individual communication path segments are maintained for a desired time duration in order to attain successful communication. In any type of communication there is typically a certain amount of data that needs to be transmitted (or received), and in order for complete transmission of this data, a link/path must be maintained for a minimum period of time.

In the disclosed preferred AHXNET arrangements, the objective is to successfully send data d to a specific node (this being referred to as a “unicast”), or to receive data d from any node that can provide this data. Two factors affect link duration, namely the relative velocity and relative position of nodes on a path with respect to each other.

FIG. 6 is a flow chart of a process 400 for effecting communication according to the disclosed AHXNET arrangements. The process 400 commences with a step 401 in which the processor 1105 (see FIG. 3) waits for a request for communication. This request can be generated manually by a user, or can be derived from another software application or process on the aircraft 102. While no request is received, the process 400 loops as depicted by a NO arrow back to the step 401. If a communication request is received, the process 400 follows a YES arrow to a step 403 in which the processor 1105 determines if the request is to transmit a message or to receive a particular piece of information.

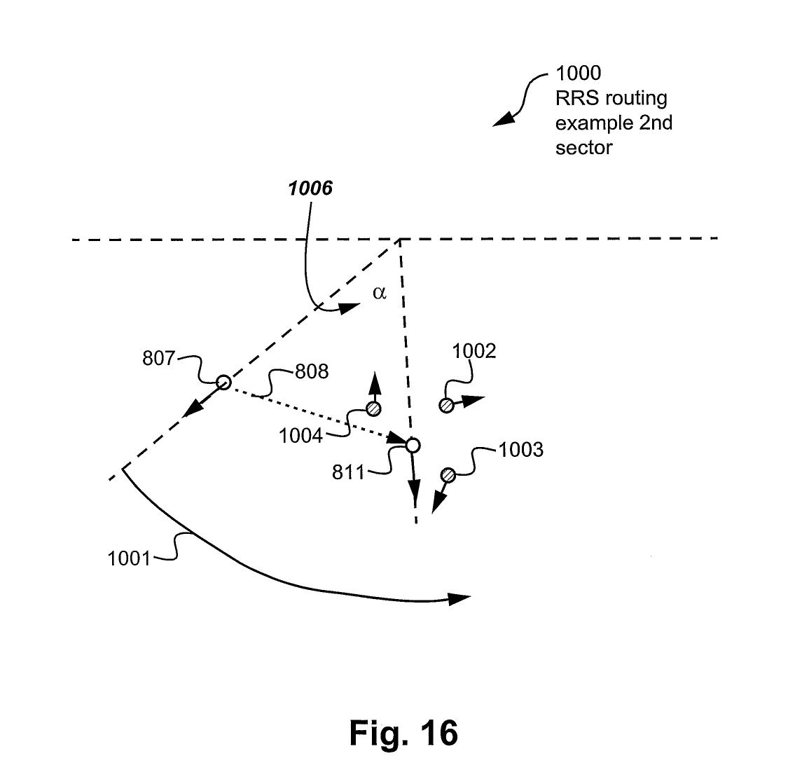

If a transmit operation is called for, then the process 400 follows a TRANSMIT arrow to a step 404 which determines the transmit path according to the AHXNET method. This is described in more detail in regard to FIGS. 14-17. A following step 406 establishes the transmit link. It is noted that the step 406 is depicted as establishing the link either in the first instance, or in a “handoff” situation where a new link has to be established before termination of a communication session, because the old link is about to fail because of movement of the aircraft.

A following step 408 determines if the link that has been established by the step 406 is acceptable. The criteria used to determine the acceptability of the communication path depend upon the particular situation, but these criteria generally relate to quality of service, bandwidth, noise and so on. If the step 408 determines that the link quality is not acceptable, then the process 400 follows a NO arrow back to the step 404 which determines a new transmit path of acceptable quality. If, on the other hand, the step 408 determines that the present link is acceptable, then the process 400 follows a YES arrow to a step 410.

The step 410 determines if the present communication session has been completed. If this is not the case, then the process 400 follows NO arrow back to the step 408. If, on the other hand, the communication session has been completed, then the process 400 follows a YES arrow from the step 410 back to the step 401.

Returning to the step 403, if it is desired to receive a particular piece of information, then the process 400 follows a RECEIVE arrow to step 405. The step 405 determines the required received path, in other words the step 405 determines the sequence of aircraft to be used for the typically multi-hop communication path that is required. A following step 407 establishes the actual communication link, which as in the case of the step 406 can either be a link in the first instance, or a handoff link if successive links are required. Thereafter, a step 409 determines if the link established by the step 407 is acceptable. If this is not the case, then the process 400 follows a NO arrow from the step 409 back to the step 405. If, on the other hand, the presently established link is acceptable, then the process 400 follows a YES arrow to a step 411.

The step 411 determines if the present communication session has been completed. If this is not the case, then the process 400 follows a NO arrow back to the step 409. If, on the other hand, the communication session has been completed, then the process 400 follows the arrow 402 back to the step 401.

FIG. 7 depicts an aeronautical mobility model. In the example depicted, the central aircraft A is looking to its neighbor aircraft to retrieve some information. If all aircraft seen by aircraft A provide the same data (and QoS), the aircraft A selects a node which remains within its LOS communication zone for the longest possible period of time, to avoid link breakage before the complete data d is received.

In FIG. 7, the preferred aircraft is B since its relative speed is closest to that of aircraft A. The relative positions of aircraft A and aircraft B also need to be taken into account.

As already noted, the aeronautical routing protocol used in the disclosed preferred AHXNET arrangement comprises the CLDP mode and the SLDP mode.

Choose Longest Duration Path (CLDP) involves an aircraft (referred to as the aircraft “requesting” the data) requesting some data d from other potential aircraft that may have the ability to provide this data. In this scenario, more than one aircraft can act as the aircraft having the data, and every aircraft that can provide d becomes a candidate for providing this data to the aircraft requesting the data. An aircraft having the necessary data is referred to as the aircraft “having” the data. The issue then becomes one of choosing the path that maximizes the likelihood that the information d will be successfully communicated before any of the aircraft in the communication path leaves it's associated LOS communication zone. As a minimum, the selected path requires a link duration long enough to execute this task (ie the communication session). A practical application of this example is accessing data cached in another plane.

Send on Longest Duration Path (SLDP) is used when an aircraft (referred to as the aircraft “providing” the data) wishes to send some data d directly to a destination (unicast) aircraft (referred to as the aircraft “getting” the data). In this case a path is needed that terminates at the destination aircraft, and has a link duration long enough to transmit d. A practical application of this is sending a file to a specific aircraft.

CLDP routing is one method used for data that may be cached in one or more aircraft throughout the network. In this case a stable path needs to be established to one of these aircraft, which retains the communication links for a long enough duration to support complete transfer of this data. Assuming that a user is inside aircraft A and wants to download a rare song that is not stored on the on-board database of plane A. The user does not know where this song is stored (eg it might be a Latin song, which may be stored on an aircraft flying over South America), so the AHXNET arrangement in the users aircraft broadcasts a request to all single-hop (neighbor) aircraft, that are present in the line-of-sight communication zone of the user's aircraft. In this broadcast packet, there is a request for this data along with other routing information. When the neighboring aircraft receive this packet, they firstly determine whether the requested data is stored on their on-board database. If the music is stored locally, the neighboring aircraft in question sends a reply packet back to the requesting aircraft (plane A). If the desired information is not stored locally, the neighboring aircraft rebroadcasts the request packet to their next-hop neighbors in their respective (LOS) communication zones.

After some time, plane A will receive one or more positive replies, presuming that the desired file is stored somewhere in an aircraft in the aircraft network layer 202. These replies represent various communication paths that enable the data to be retrieved. The next issue is for the appropriate path to be identified.

Assuming that the Quality of Service (QoS) for all the possible paths is equivalent (or at least acceptable) it is in the first instance possible to select the path with the least number of hops. This is one solution for use in the AHXNET arrangement.

In another arrangement, the most stable path, ie the path offering the longest link duration can be selected. The path duration depends upon the relative velocity and position of the nodes on this path. If, for the sake of simplicity, it is assumed that all aircraft in the aircraft network layer 202 have the same speed, are flying linear routes, and have different directions, it is apparent that the most suitable path that offers the longest link duration is the path associated with aircraft having relative velocities (ie speed and direction) that are close to each other.

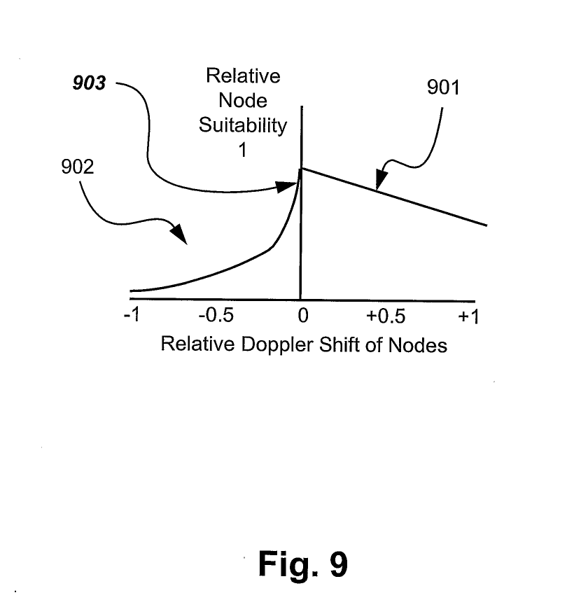

FIG. 8 depicts establishment of a suitable receive path taking the mobility behaviour of aircraft into account. In this example it is noted that the aircraft need not necessarily be going to the same destination.

Each (radio transmitted) reply packet received by the aircraft A in response to aircraft A's request is subject to a Doppler shift which depends on the relative motion of the replying aircraft (ie the aircraft having the desired data) to the requesting aircraft A. The Doppler shift is the apparent change in frequency of transmitted electromagnetic signals due to the relative motion of the transmitter and receiver. The preferred solution set contains aircraft (having the requested data) that have relative velocities close to zero with reference to the aircraft requesting the data. This means that the velocity vectors (speed and direction) of the candidate aircraft having the data are close to each other and to the velocity vector of the aircraft requesting the data, as shown in FIG. 8. These nodes consequently have Doppler shifts close to zero when measured by the AHXNET system on the requesting aircraft. In the limiting case, when two nodes (aircraft) that are in a common LOS communication zone and have equal velocity vectors (relative velocity and Doppler shift of zero), the aircraft will remain within a common LOS communication zone indefinitely, so long as they retain their current motion parameters.

The closer the velocity vectors of the respective nodes, the longer it takes for the nodes to exit from each other's LOS communication zone. However, as mentioned earlier, the relative position or distance of the nodes also affects the link duration.

In order to find the most suitable path the reply packet with the least Doppler shift can be used. In the simple case, the relative position of the aircraft having the data is not taken into consideration. It is noted that the reply packet in question can be associated with a multi-hop path, in which case it will have been subjected to Doppler shifts as it traversed through the AHXNET system of each aircraft on the path to the requesting node. The Doppler shift in this case is the sum of the relative Doppler shifts (and hence velocities) of the replying nodes making up the communication path in question.

A more accurate measure of suitability of path is to estimate the Path Duration as a measure of both Doppler Shift of packet and the power of the signal. Thus the estimated Link Duration Time using Doppler shift of packets and power signal (of packets) is given by the following relationship:

$$\begin{matrix}{LDT}_{i} = \frac{R + {d}_{i}}{c ( \frac{f}{{f}_{0}} - 1 )} … ( if \frac{f}{{f}_{0}} < 1 ) ( Approaching ) & [ 2 A ] \\ {LDT}_{i} = \frac{R - {d}_{i}}{c ( \frac{f}{{f}_{0}} - 1 )} … ( if \frac{f}{{f}_{0}} > 1 ) ( Receding ) & [ 2 B ]\end{matrix}$$

where the initial distance between two nodes dᵢ is given by the following relationship:

$${d}_{i} = \frac{λ}{4 π} \sqrt{\frac{{p}_{t}}{{p}_{r}}} \qquad [ 2 C ]$$

where R is the maximum communication range between two mobile nodes, pᵣ is the initial received signal power, pₜ is the known transmission signal power and λ is the carrier's wavelength.

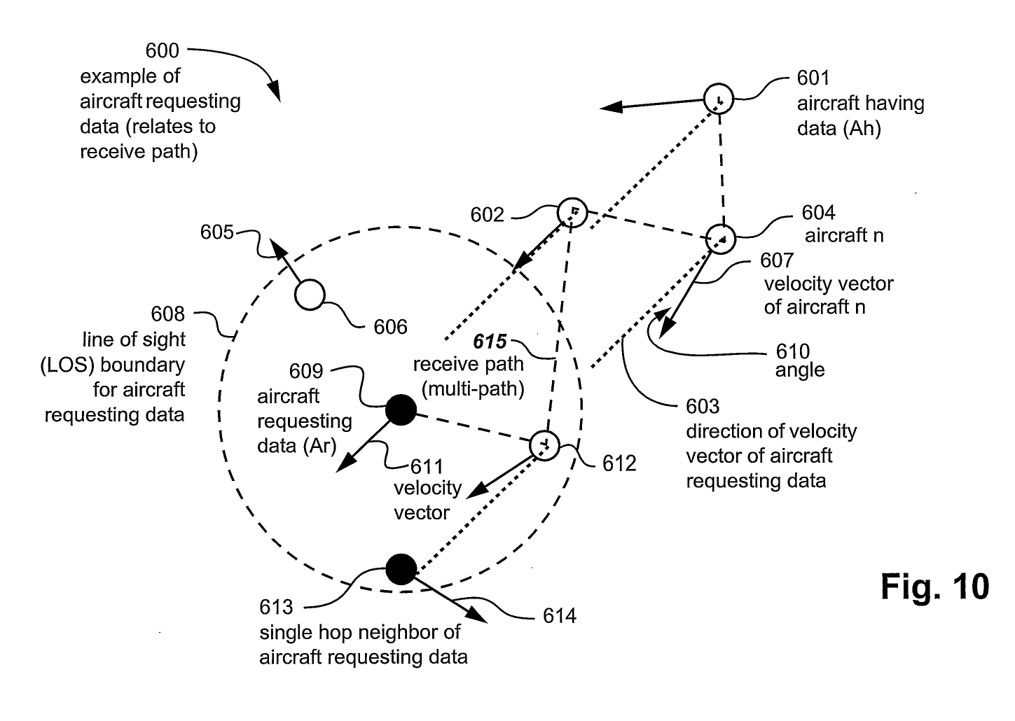

FIG. 9 depicts relative node suitability as a function of Doppler shift for an aircraft requesting data. A rough guide for the relative node suitability with respect to Doppler shifts is shown, and it is noted that nodes approaching each other have positive Doppler shifts, whilst nodes receding from each other have negative Doppler shifts. In general nodes approaching each other (see 901) offer better suitability measures (node suitability metric) than nodes receding from each other (see 902), unless the rate at which the aircraft are receding from each other is very small, this case being characterized by a very small negative Doppler shift depicted by 903 (see FIG. 9).

It is also noted that the distance between the planes affects the time for which they will remain within a common LOS communication zone. Thus, for example, if two nodes (aircraft) having the requested data have equal velocity vectors and are both approaching the requesting node, generally the aircraft having the data that is further away from the aircraft requesting the data will remain in the LOS communication zone of the aircraft requesting the data for a longer period than the node which is closer to the requesting aircraft.

Generally if nodes are receding from each other, it is better to select the nodes closest to the requesting node, whilst if nodes are approaching each other, it is better to select the furthest away node respectively in order to increase link duration.

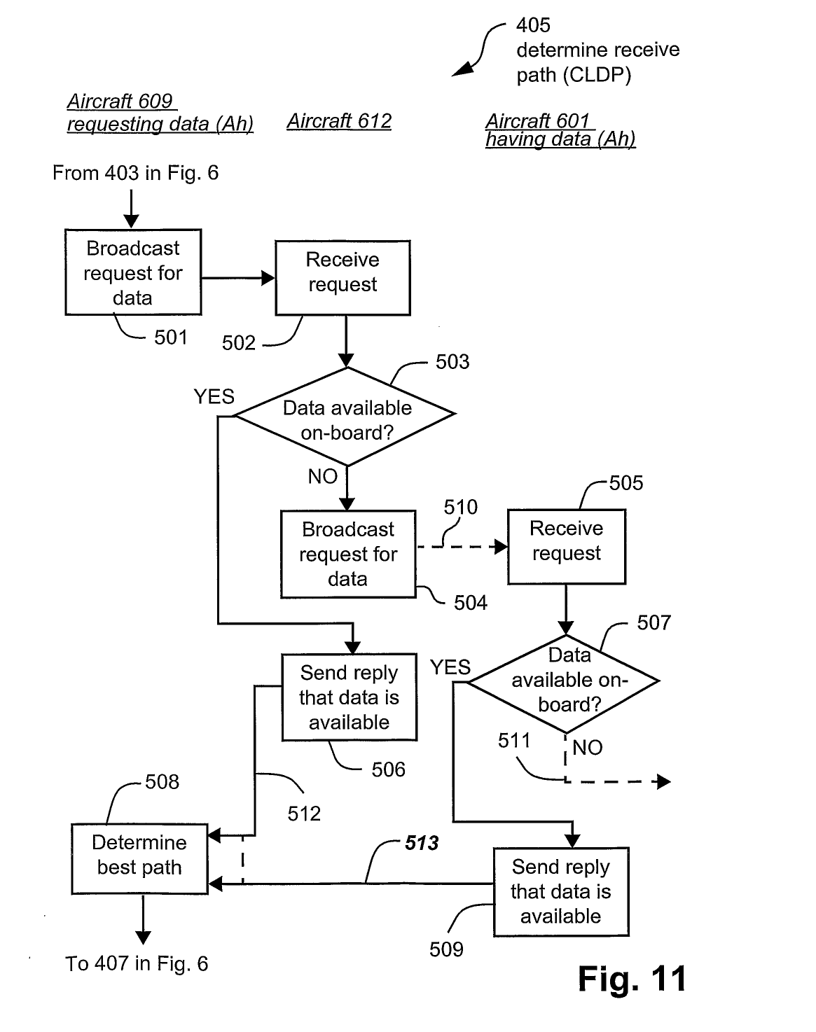

FIG. 10 depicts an AHXNET receive path example, showing a number of aircraft used to form a receive path 615 between an aircraft 609 requesting data and an aircraft 601 having the requisite data. The aircraft 609 requesting the data, this aircraft being referred to as Aᵣ, has a line of sight (LOS) communication zone 608 within which the aircraft 609 is able to see other aircraft. The term “line of sight” is generally taken to refer to visual objects, however it is equally applicable in the present description to wireless communications, and it is in the wireless communication context that the term is used. The line of sight communication zone 608 is seen to contain three other aircraft 606, 612 and 613. These aircraft 606, 612 and 613 are referred to as the single-hop neighbours of the aircraft 609 requesting the data. The aircraft 609 requesting the data has a velocity vector 611 indicating both the direction and magnitude with which the aircraft 609 is travelling. The single-hop neighbours 606, 612 and 613 have corresponding velocity vectors exemplified by a velocity vector 605 that is associated with the aircraft 606.

The aircraft 601 having the data lies outside the line of sight communication zone 608 of the aircraft 609 requesting the data. Accordingly, the receive path 615 is a multi-hop path extending outside the line of sight communication zone 608.

In addition to the aircraft 601 having the desired data, two other aircraft 602 and 604 are in flight outside the line of sight communication zone 608. The aircraft 601, 602 and 604 each have associated velocity vectors. Thus, for example, the aircraft 604 has an associated velocity vector 607 that deviates by an angle 610 from a dotted line 603 that is parallel to the velocity vector 611 of the aircraft 609 requesting the data.

The received path 615 is seen to extend from the aircraft 601, in a multi-hop fashion, via the successive aircraft 604, 602, 612 and finally to the aircraft 609 requesting the data.

Each of the aircraft 601, 604, 602 and 612 have associated velocity vectors that deviate by corresponding angles from the direction of the velocity vector 612 associated with the aircraft 609 requesting the data. The aforementioned deviation angles will determine the relative velocities of each aircraft from the aircraft 609 requesting the data. These relative velocities each cause an associated Doppler shift of the communication packet transiting the corresponding aircraft.

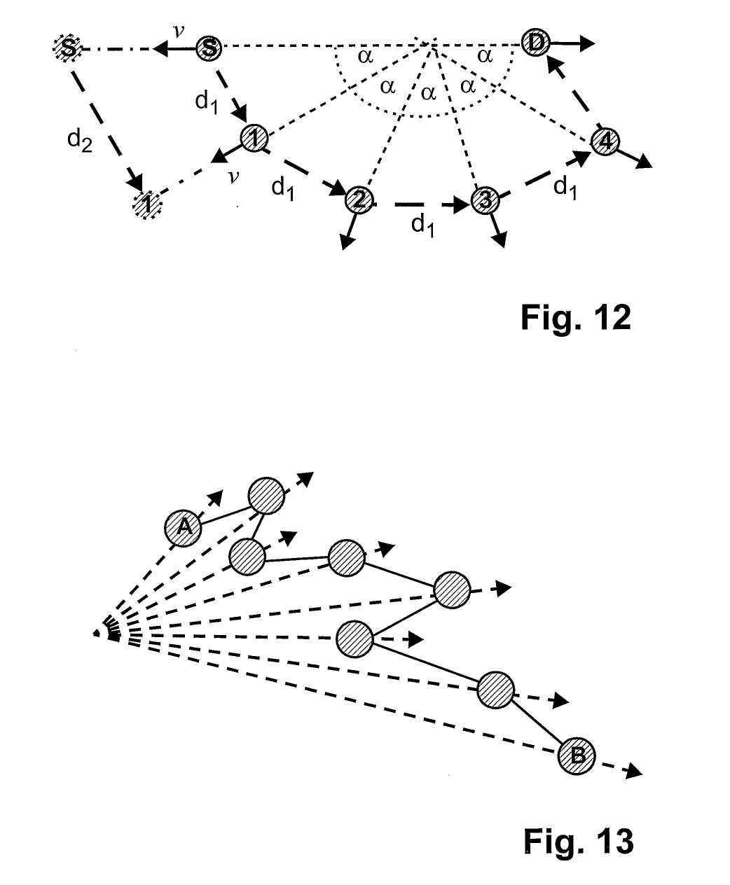

FIG. 11 shows a process flow chart of how the example of FIG. 10 is derived. FIG. 11 shows the step 405 from FIG. 6 in more detail. The sub-process 405, which is preceded by the step 403 in FIG. 6 commences with a step 501 in which the aircraft 609 requesting data (see FIG. 10) broadcasts a request for data to all the aircrafts in the region. The aforementioned request generated by the aircraft 609 requesting the data in the step 501, is received in a step 502 by the aircraft 612 (see FIG. 10) in a step 502. Having regard to the aircraft 612, the AHXNET processing system on board the aircraft 612 receives the request in the step 502, after which this processing system performs the step 503 that determines if the data requested by the aircraft 609 is cached in the AHXNET processing system on board the aircraft 612. If this is not the case, then the processing system on board the aircraft 612 re-broadcasts the request for data in a step 504.

In the present example, therefore, the request for data that originates with the aircraft 609 is successively re-broadcast in an outward going fashion by successive aircraft which receive the request and which do not have the required data on board. In order to prevent the unrestricted re-broadcast of this request beyond a desired maximum distance from the aircraft 609 requesting the data, the request packet broadcast by the aircraft 609 can contain the geographic location of the aircraft 609 (derived, for example using the Global Positioning System), and the re-broadcast of the request can be made contingent upon a maximum hop-count or other predefined Quality of Service (QoS) limits (for example it may be determined that the additive propagation delay has become too long, or the power of the signal has become deteriorated and unacceptable).

On the presumption that the aircraft 612 is not beyond the aforementioned maximum distance or limit of re-broadcast rules (specified in the packet header), the aircraft 612 in the step 504 re-broadcasts the request as depicted by a dashed arrow 510. In FIG. 11, the aforementioned re-broadcast request transits the aircraft 602 and 604 and is received in a step 505 by the AHXNET processing system on board the aircraft 601 having the data. It is noted that when the description refers to an aircraft performing a processing function, this is merely shorthand for saying that the AHXNET processing system on board the aircraft in question performs the noted function.

Turning to the aircraft 601 having the information, following the step 505, a step 507 determines if the data is available on board. If this is not the case, then the process 405 follows a NO arrow to a subsequent aircraft. If, on the other hand, the data is available on-board the aircraft 601, then the process 405 follows a YES arrow from the step 507 to a step 509. In the step 509, the aircraft 601 sends a reply packet back towards the aircraft 609 making the request indicating that the data is available.

Returning to the aircraft 612, and in particular to the step 503, if the step 503 determines that the aircraft 612 does have the required data on-board, then the process 405 follows a YES arrow from the step 503 to a step 506. In the step 506, the aircraft 612 sends the reply via a dashed arrow 512 back to the aircraft 609 requesting the data, this reply being processed by a step 508. Returning to the step 509 that relates to the aircraft 601 having the data, the process 405 follows an arrow 511 from the step 509 to the step 508.

In the step 508 the aircraft 609 requesting the data determines the desired path by considering each of the reply packets received from the various aircraft having the data. In one arrangement, the step 508 considers the Doppler shift in each of the requested packets, and selects the received packet having the lowest Doppler shift as indicating the best route. Once the step 508 has determined the best path, the process 405 is directed to the step 407 in FIG. 6.

### SLDP Routing Using a Radial Routing Scheme (RRS)

This mode of routing uses the concept of position based routing which takes into account the movement characteristics of the mobile hosts in addition to their position for finding optimized routes. In SLDP there is some data d, which needs to be sent to a specific node (unicast). The same approach can be used to send data to several nodes, effectively a multicast.

For this mode, it is preferable not to use the CLDP routing scheme. This is because it is necessary to know the position of the aircraft getting the data, otherwise the direction of the broadcast will not be known. Thus the knowledge of the location of the destination airplane (ie the aircraft getting the data) and its corresponding velocity should first be known (using Global Positioning System (GPS) supplied in all aircraft). Once this knowledge is obtained, directed-broadcasting can be performed. As with CLDP, it is possible to use a shortest path routing method. Preferably however a path should be selected that has a path duration long enough to transmit the required data before the link/path breaks. It is typically necessary to go through multiple hops in order to achieve this.

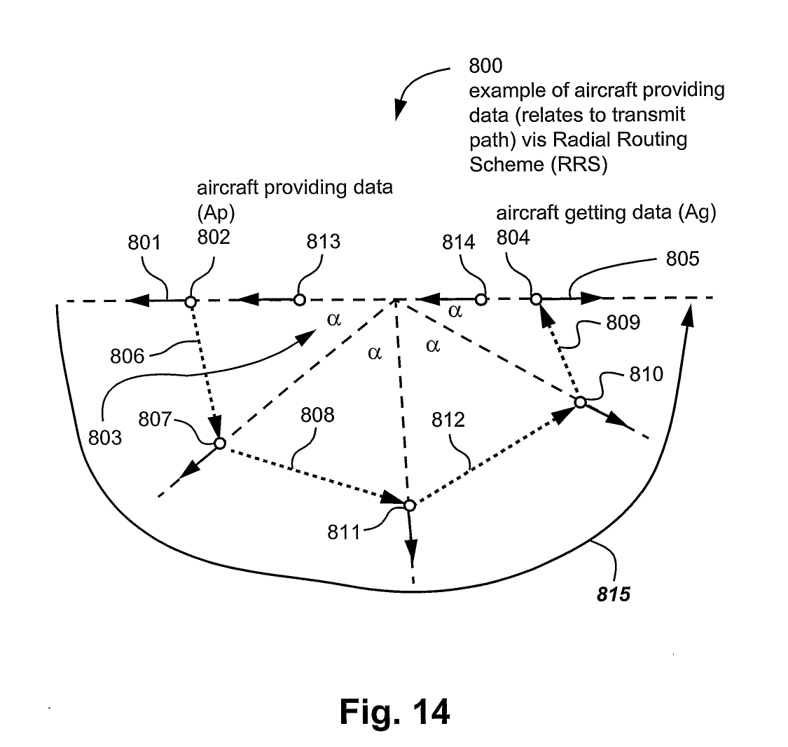

FIG. 12 depicts establishment of a transmit path in an example with receding nodes. A worst-case scenario is shown, where the destination node “D” is directly receding from the source node “S”. As mentioned previously, the nodes that have smaller relative velocities stay within each other's LOS communication zone for a longer period of time. A series of nodes is required that links between the source “S” and destination “D” nodes and which provide a link duration of at least t_{d}, which is the minimum time for a data d to be transmitted. Therefore any link in the path must have a link duration of at least t_{d}.

In FIG. 12, it is assumed that node 1 is the neighbor of source node (node S). We assume node 1 is d₁ meters away from S, and that the angle of their relative velocity vectors is α. After some time, the node S and the node 1 move to a new position where they are d₂ meters away from each other. If d₂>d_{LOS} then the link breaks, where d_{LOS} is the maximum range of communication between two nodes. Hence we need to consider the time taken from the initial distance d₁ and the final distance d₂ where the link is maintained.

The relative velocity ν_{R} of node 1 with respect to node S is as follows:

$${v}_{R} = v \sqrt{2 ( 1 - cos α )} = 2 v sin ( \frac{α}{2} ) \qquad [ 3 ]$$

The connection time t_{c} for which a link is maintained between the two nodes is as follows:

$${t}_{c} = \frac{{d}_{LOS} - {d}_{inital}}{2 v sin ( \frac{α}{2} )} \qquad [ 4 ]$$

where dᵢₙᵢₜᵢₐₗ is the initial distance the two nodes were originally, when they established the link.

From equation [4] it is seen that as the initial distance of the two nodes decreases, their relative velocities can afford to be greater to maintain the same link duration.

Consecutively we need to produce a path to the destination where all links on this path have a link duration of t_{c}≧t_{d}. In order to do this we need to adapt the same method of finding nodes that follow equation [4] and lead to the vicinity of node D. A Radial Routing Scheme (RRS) is used, this being depicted in FIG. 12 for the case where all consecutive nodes on the path are initially the same distance d₁ apart. The RRS works as follows:

1. Take the shortest radial arc from the direction of motion of source (ie the aircraft providing the data) to that of the destination (ie the aircraft getting the data);
2. Choose neighbor nodes within the sector described by the aforementioned arc that would provide the minimum connection time specified by equation [4] by considering their relative velocity and position.

The steps taken in RRS involve the knowledge of the position and velocity of neighboring nodes, which can be found using GPS. We also know that time taken to transmit our data takes time t_{d}. Thus in order to choose suitable nodes within the sector, we need to look at the relative velocity and distances between neighbor nodes. Suitable nodes must satisfy the following:

dₙ≦d_{LOS}−ν_{R}t_{d} [5]

where dₙ is the distance between neighboring nodes in a path.

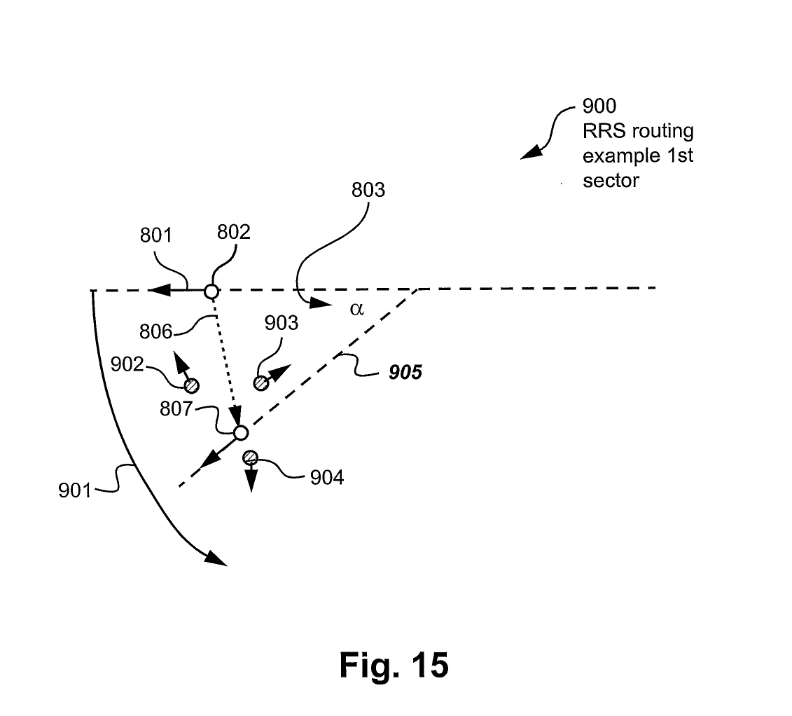

FIG. 13 shows an example of establishment of a transmit path using a Radial Routing Scheme, including sectorizing the route discovery region using RRS. All nodes in this figure satisfy equation [5] and hence all links on the selected path from node A to node B have link durations greater than t_{d}.

FIG. 14 shows an AHXNET transmit path example 800 of a number of aircraft forming a transmit path is formed via a radial routing scheme (RRS). In the example 800, an aircraft 802 having an associated velocity vector 801 wishes to provide (send) data to an aircraft 804 having an associated velocity vector 805. The aircraft 802 providing the data as referred as Aₚ and the aircraft 804 getting the data is referred to as A_{g}. On the presumption that a multi-hop transmit path is required, because the aircraft 804 getting the data lies outside the line of sight communication zone of the aircraft 802 providing the data, in one arrangement the transmit path can be established between the aircraft 802, via aircraft 813 and 814, to the aircraft 804. In this event, however, since the aircraft 814 and the aircraft 804 are travelling in diametrically opposed directions, the transmit time t_{d} available for the transmit path segment between the aircraft 814 and the aircraft 804 may be too short to enable the desired data to be transmitted without re-establishing a new path.

In an alternate arrangement, a multi-hoc transmit path is set up from the aircraft 802 providing the data, via successive aircraft 807, 811 and 810, and finally to the aircraft 804 getting the data. Each successive pair of aircraft forming corresponding communication path segments in this arrangement have their associated velocity vectors diverging from each other by an angle “α” 803. By selecting a suitable angle α, the radial difference 815 between the velocity vector 801 of the aircraft 802 and the velocity vector 805 of the aircraft 804 is “sectorised” into sufficient sectors so that each successive pair of aircraft have an associated transmission time t_{d} which is sufficient to support transmission of the desired data.

It is noted that the RRS effectively selects aircraft having a common point of intersection (from which “α” is derived). In one example, the aircraft could be originating from the same location, (the same airport) but heading to various destinations. In another example, the aircraft could be originating from various points-of-origin, however at some point the aircraft will all have a common point of intersection during their flight journey. The aircraft must be radially moving away from the aforementioned point of intersection.

FIGS. 15 and 16 show successive snapshots of how the transmit path example of FIG. 14 is determined.

FIG. 15 shows an RRS routing example fragment 900 for the first sector of the arrangement 800 shown in FIG. 14. The aircraft 802 providing the data identifies a number of candidate aircraft 902, 903, 904 and 807 located in the proximity of a dashed line 905 which diverges at the angle α (ie., 803) from the velocity vector 801 of the aircraft 802. The AHXNET processor on board the aircraft 802 determines the transmission time t_{d} that would be available by forming a communication path segment between the aircraft 802 and each of the aforementioned aircraft 902, 903, 904 and 807. The AHXNET processor on board the aircraft 802 determines that the transmission time t_{d} is most suitable if the transmission path segment is formed between the aircraft 802 and the aircraft 807, and this communication path segment is depicted by a dashed arrow 806.

FIG. 16 shows a depiction 1000 of the aforementioned RRS routing example applied to the second sector of the example 800 in FIG. 14. The aircraft 807 performs the same processing as previously described in relation to the AHXNET processor on board the aircraft 802. In this case, the AHXNET processor on board the aircraft 807 determines the transmission time t_{d} which would be provided if a communication path segment were established between the aircraft 807 and each of the candidate aircraft 1004, 1003, 1002 and 811. The aircraft 807 determines that the optimum transmission time is available for a communication path segment between the aircraft 807 and the aircraft 811, and this communication path segment is depicted by a reference numeral 808.

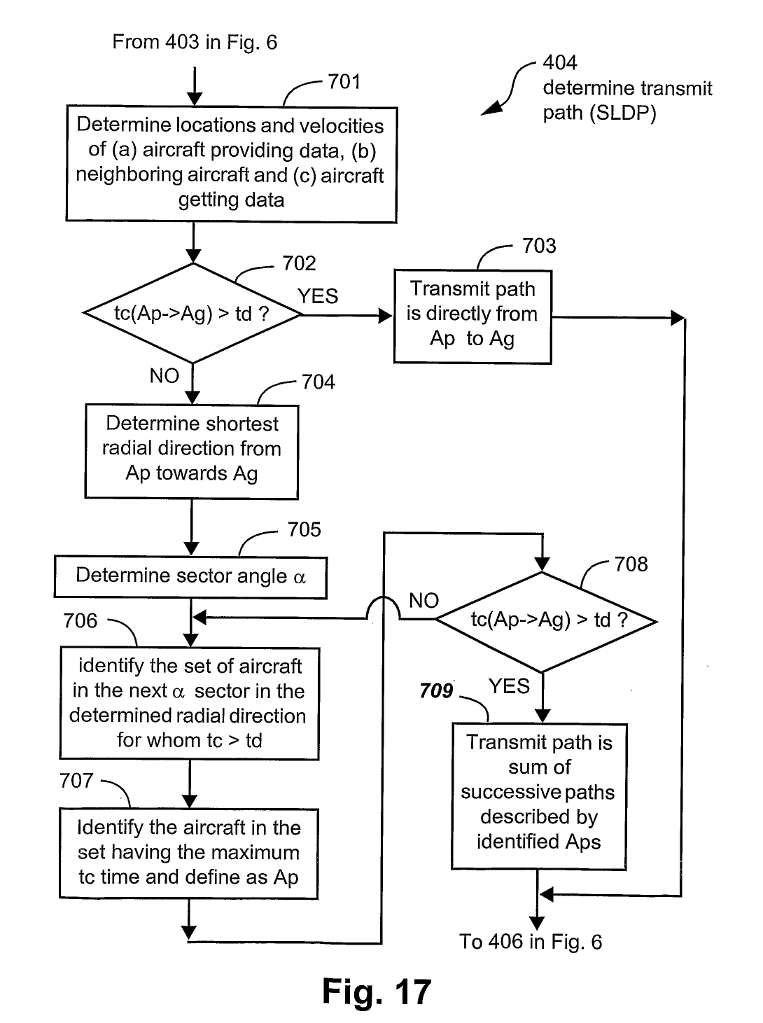

FIG. 17 shows a process flow chart of how the example of FIG. 14 is derived. FIG. 17 shows an example of the step 404 from FIG. 6 this example in FIG. 17 determining the transmit path using the RRS approach described in relation to FIGS. 14-16. The process 404 follows after the step 403 in FIG. 6, and commences with a step 701 in which the AHXNET processor on board the aircraft 802 providing the data (see FIG. 14) determines the locations and velocities of the aircraft depicted in FIG. 14. If 802 and 804 are within range of each other, then in a following step 702, the aircraft 802 determines if the communication time t_{d} directly from the aircraft 802 providing the data and the aircraft 804 getting the data is greater than the required transmission time t_{d}. If this is the case, then a single-hop transmission path can be set up, and the process 404 follows a YES arrow to a step 703 which sets up the transmit path directly from Aₚ to A_{g}. The process 404 then is directed to the step 406 in FIG. 6.

Returning to the step 702, if the available transmission time is insufficient, then the process 404 follows a NO arrow to a step 704. In the step 704, the aircraft 802 determines the shortest radial direction from Aₚ towards A_{g}, this shortest radial direction being indicated by an arrow 901 in FIG. 15. In a following step 705, the aircraft 802 determines the necessary sector angle α which is required in order to obtain the necessary transmission time.

Thereafter, in a step 706, the aircraft 802 identifies the set of aircraft in the corresponding α sector (subtended by the angle 803) in the determined radial direction for whom the communication time t_{c} is greater than the required communication type t_{d}. Referring back to FIG. 15, in the step 706 the aircraft 802 identifies the aircraft 902, 903, 904 and 807 as having t_{c} greater than t_{d}. In a following step 707, the aircraft Aₚ identifies the aircraft in the aforementioned set having the maximum transmission time t_{c}. In regard to FIG. 15, the aircraft 802 would, according to the step 707, identify the aircraft 807 as providing the minimum required transmission time whilst meeting the RRS criterion. In the step 707, the respective AHXNET processors on board the aircraft 802 and the aircraft 807 define the aircraft 807 as the aircraft to perform the next sector identification process, and thus define the aircraft 807 as Aₚ. In a following step 708, the aircraft 807, now designated as Aₚ determines if the transmission time associated with the pair of aircraft Aₚ, A_{g} is greater than the required transmission time t_{d}. If this is not the case, then the process 404 follows a NO back to the step 706.

In the step 706, the aircraft 807, presently designated as Aₚ, identifies the set of aircraft in the next α sector (as depicted in FIG. 16) for whom the associated transmission time t_{c} is greater than the minimum required transmission time t_{d}. Having regard to FIG. 16, this means that the aircraft 807, now designated as Aₚ evaluates the available transmission time associated with communication path segments set up with each of the candidate aircraft 1004, 1002, 1003 and 811. In the step 707, the aircraft 807 selects the aircraft 811 as providing the greatest transmission time, and establishes the communication path segment 808.

Returning to the steps 707, if the available transmission time is greater than the minimum required, then the process 404 follows a YES arrow to a step 709. In the step 709, the transmission path made up of successive communication path segments each providing the best communication time is set up as a concatenation of successive communication path segments. Having regard to FIG. 8, this transmit path is made up by the concatenation of successive communication path segments 806, 808, 812 and 809.

### Other Issues of Concern

### Security

Security is an important issue in the disclosed AHXNET arrangements, as measures are necessary to prevent, for example, a rogue aircraft exploiting messages within the network. The Public Key Infrastructure (PKI) is used for encryption purposes in the disclosed AHXNET arrangements. All registered commercial aircraft obtain (a) a private key for decrypting messages and (b) the public key of all commercial aircraft that they could communicate to. Messages sent to a particular destination aircraft is encrypted with that aircraft's public key, and only the intended aircraft can decrypt data sent to it (using its own private key). Hence even if messages are routed through rogue aircraft, the rogue aircraft will not be able to decrypt the messages.

Before an aircraft having data (such as 601 in FIG. 10) sends the data to the requesting aircraft (ie 609 in FIG. 10), the replying aircraft 601 performs authentication with the requesting aircraft 609. It is only when the aircraft 609 has been authenticated that encrypted data can be forwarded to that aircraft.

The aircraft 609 sends a signed request, encrypting the request packet with the private key associated with the aircraft 609, to the aircraft 601 (and to other aircraft to whom the request is sent). The replying aircraft 601 decrypts the message the public key associated with the aircraft 601 to thereby authenticate the aircraft 609.

The destination aircraft 601 then encrypts the requested data using the public key of the source aircraft 609 (obtained from a Certificate Authority) and sends this data back to the requesting aircraft 609. The requesting aircraft 609 then decrypts this data using its private key.

### Signal Attenuation

Communication signals of high frequency experience attenuation, due to the atmosphere and particularly to rain, especially if the Ku band (used today for aeronautical broadband satellite communication) is used. However for the disclosed AHXNET arrangements, high frequency communications are not necessary, and lower frequency bands such as the C band can, if desired, be used as distances are much shorter than communication via satellite, and most applications that will be used are not real-time and hence not bandwidth hungry.

### Simulation of Protocol for Single-hop Routing

Simulations using varying node densities have been performed to demonstrate the effect of mobility on link duration. In the simulations the nodes (aircraft) move about with linear motion in all directions with constant speed for a fixed period of time. This simulates a scenario where a node needs to obtain some data from any other node. All nodes can process the request and contain the requested data.

In the simulation scenarios when an associated node leaves the requesting node's communication zone or line-of-sight, a new routing decision must take place. There are two routing schemes.

Scheme 1 works on the simple principle as follows:

1. Choose closest node for routing.
2. Repeat when associated node leaves LOS.

Scheme 2 is performed as follows:

Out of nodes within range,

1. select the node with closest relative velocity.
2. Repeat when associated node leaves LOS.

Scheme 2 integrates the proposed mobility metric in choosing suitable nodes and effectively simulates CLDP, whereas Scheme 1 is simply the traditional “shortest path” routing scheme. The two routing schemes have been simulated and the average link duration for the entire simulation period for each routing scheme have been calculated.

### Numerical Results and Discussions

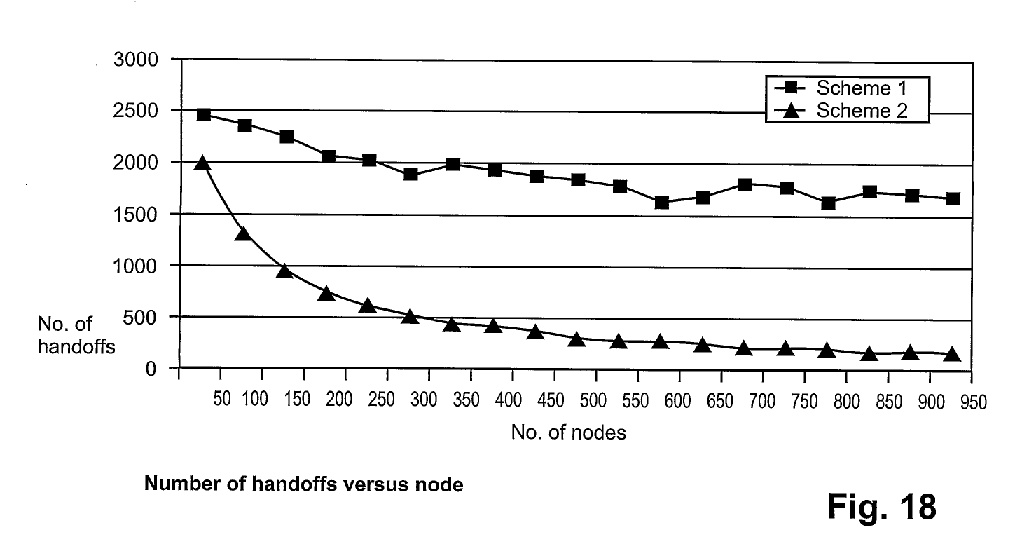

Two sets of simulations were performed. One simulation shows average link durations with respect to number of handoffs by keeping the number of nodes to a constant 100 over a period of time. Table I shows the results of this simulation. The second simulation involved increasing node density and observing the effect on the two routing schemes with relation to the number of handoffs during the total simulation period. The nodes are simulated in an area of 111 km². FIG. 18 shows the result of this simulation.

TABLE I
Sample Simulation Results

| | Routing Information | |
|---|---|---|
| | Average | |
| | Link | No. of |
| Scheme | Duration (s) | Handoffs |
| 1 | 6.74 | 750 |
| 2 | 26.49 | 200 |

Note that the number of handoffs is inversely proportional to the link duration, as link duration equals total simulation time divided by the number of handoffs. As the number of nodes (i.e. node density) increases, there are more nodes within range for routing. In scheme 1, simply the closest one is chosen, whilst in scheme 2, the nodes that have the closest relative velocity to the requesting node are chosen.

As the node density increases, there are more candidate nodes, and hence in Scheme 2, there are more nodes that have closer velocities to the requesting node, and since those nodes are chosen, the number of handoffs decreases, and hence link duration increases. From the results, it appears that scheme 2 that integrates a mobility parameter into path selection, outperforms the scheme 1, especially when node density increases.

This simulation demonstrated the proposed schemes for single-hop routing scenarios. Similar simulations can also be performed for multi-hop arrangements, as the principal of AHXNET routing is fundamentally the same. Instead of one node having relative velocities close the requesting node, a path is taken where all nodes on the path have a relative velocity close the requesting node.

### INDUSTRIAL APPLICABILITY

It is apparent from the above that the arrangements described are applicable to the telecommunication industry.

The foregoing describes only some embodiments of the present invention, and modifications and/or changes can be made thereto without departing from the scope and spirit of the invention, the embodiments being illustrative and not restrictive.

1. A method of establishing, in-flight, a communication path between a first aircraft and a second aircraft, the method comprising the steps of:
identifying another aircraft;
determining relative velocities between at least some of the first aircraft the second aircraft and the other aircraft;
matching the relative velocities against a criterion; and
establishing, if said relative velocities match the criterion, communication path segments between successive pairs of said first aircraft, said second aircraft and said other aircraft to thereby form the communication path.

2. A method according to claim 1, wherein:
the step of determining relative velocities comprises transmitting a communications packet from the second aircraft via the other aircraft to the first aircraft, and determining the Doppler shift associated with the communications packet; and
the step of matching the relative velocities against the criterion comprises determining if the Doppler shift is less than a threshold.

3. A method according to claim 1, wherein the step of matching the relative velocities against the criterion comprises determining if each of said relative velocities are less than a threshold.

4. A method according to claim 1, wherein:
the step of matching the relative velocities against the criterion comprises determining if successive pairs of the relative velocities are less than a threshold.

5. A communications network architecture enabling a first aircraft to establish a communication path with a second aircraft, said architecture comprising:
a satellite network layer enabling the first aircraft to establish said communication path with the second aircraft via a satellite;
a terrestrial network layer enabling the first aircraft to establish said communication path with the second aircraft via the satellite, and an associated ground station; and
an aircraft network layer enabling the first aircraft to establish said communication path with the second aircraft via another aircraft.

6. A communication network architecture according to claim 5, wherein the communication path between the first aircraft and the second aircraft via the other aircraft is established according to the method of claim 1.

7. A system for establishing, in-flight, a communication path between a first aircraft and a second aircraft, the system comprising:
means for identifying another aircraft;
means for determining relative velocities between at least some of the first aircraft the second aircraft and the other aircraft;
means for matching the relative velocities against a criterion; and
means for establishing, if said relative velocities match the criterion, communication path segments between successive pairs of said first aircraft, said second aircraft and said other aircraft to thereby form the communication path.

8. A system for establishing, in-flight, a communication path between a first aircraft and a second aircraft, the system comprising:
one or more memories for storing a program; and
one or more processor for executing the program, said program comprising:
code for identifying another aircraft;
code for determining relative velocities between at least some of the first aircraft the second aircraft and the other aircraft;
code for matching the relative velocities against a criterion; and
code for establishing, if said relative velocities match the criterion, communication path segments between successive pairs of said first aircraft, said second aircraft and said other aircraft to thereby form the communication path.

9. A computer program for directing one or more processors to execute a procedure for establishing, in-flight, a communication path between a first aircraft and a second aircraft, said program comprising:
code for identifying another aircraft;
code for determining relative velocities between at least some of the first aircraft the second aircraft and the other aircraft;
code for matching the relative velocities against a criterion; and
code for establishing, if said relative velocities match the criterion, communication path segments between successive pairs of said first aircraft, said second aircraft and said other aircraft to thereby form the communication path.

10. A computer readable medium upon which is recorded a computer program for directing one or more processors to execute a procedure for establishing, in-flight, a communication path between a first aircraft and a second aircraft, said program comprising:
code for identifying another aircraft;
code for determining relative velocities between at least some of the first aircraft the second aircraft and the other aircraft;
code for matching the relative velocities against a criterion; and
code for establishing, if said relative velocities match the criterion, communication path segments between successive pairs of said first aircraft, said second aircraft and said other aircraft to thereby form the communication path.

11. A communication message communicated using any one of the above-noted methods or systems.

12. A method of establishing, in-flight, a communication path between a first aircraft and a second aircraft, the method comprising the steps of:
identifying another aircraft;
determining relative velocities between some or all of the first aircraft, the second aircraft and the other aircraft;
matching the relative velocities against a criterion; and
establishing, if said relative velocities match the criterion, said communication path between the first aircraft and the second aircraft via said other aircraft.

13. A method of establishing, in-motion, a communication path between a first mobile platform and a second mobile platform, the method comprising the steps of:
identifying another mobile platform;
determining relative velocities between at least some of the first mobile platform the second mobile platform and the other mobile platform;
matching the relative velocities against a criterion; and
establishing, if said relative velocities match the criterion, communication path segments between successive pairs of said first mobile platform, said second mobile platform and said other mobile platform to thereby form the communication path.

14. A method of establishing, in-flight, a communication path between a first aircraft and a second aircraft, the method comprising the steps of:
identifying a plurality of other aircraft;
determining relative velocities between some or all of the first aircraft, the second aircraft and the plurality of other aircraft;
selecting at least some of the plurality of aircraft dependent upon the relative velocities; and
establishing successive communication path segments between successive pairs of the at least some of the plurality of aircraft, wherein a concatenation of said successive communication path segments forms said communication path.

15. A method according to claim 14 wherein the selecting step comprises selecting from the plurality of aircraft those successive pairs of aircraft whose corresponding successive communication path segments when concatenated form a communication path having an estimated duration that exceeds a predetermined minimum duration.

16. A method according to claim 15, wherein:
the selecting step selects more than one set of successive pairs of aircraft whose corresponding successive communication path segments when concatenated form a communication path having an estimated duration that exceeds the predetermined minimum duration; and
the selected set comprising the fewest aircraft is used to establish the communication path.

17. A method according to claim 15, wherein:
the selecting step selects more than one set of successive pairs of aircraft whose corresponding successive communication path segments when concatenated form a communication path having an estimated duration that exceeds the predetermined minimum duration; and
the selected set comprising those successive pairs of aircraft whose corresponding successive communication path segments when concatenated form a communication path having a maximum estimated duration is used to establish the communication path.

18. A method according to claim 14, wherein the selecting step utilizes one of the following methods:
choose longest duration path as herein defined;
send on longest duration path as herein defined; and
radial routing as herein defined.

19. A system for establishing, in-flight, a communication path between a first aircraft and a second aircraft, the system comprising:
one or more memories for storing a program; and
one or more processor for executing the program, said program comprising:
code for identifying a plurality of other aircraft;
code for determining relative velocities between some or all of the first aircraft, the second aircraft and the plurality of other aircraft;
code for selecting at least some of the plurality of aircraft dependent upon the relative velocities; and
code for establishing successive communication path segments between successive pairs of the at least some of the plurality of aircraft, wherein a concatenation of said successive communication path segments forms said communication path.

20. A computer readable medium upon which is recorded a computer program for directing one or more processors to execute a procedure for establishing, in-flight, a communication path between a first aircraft and a second aircraft, said program comprising:
code for identifying a plurality of other aircraft;
code for determining relative velocities between some or all of the first aircraft, the second aircraft and the plurality of other aircraft;
code for selecting at least some of the plurality of aircraft dependent upon the relative velocities; and
code for establishing successive communication path segments between successive pairs of the at least some of the plurality of aircraft, wherein a concatenation of said successive communication path segments forms said communication path.
